(19) United States
(12) Patent Application Publication
(10) Pub. No.: US 2006/0028916 A1
(43) Pub. Date: Feb. 9, 2006

(54) Acoustic telemetry installation in subterranean wells

(76) Inventors: David McMechan, Duncan, OK (US); Wallace R. Gardner, The Woodlands, TX (US); Phillip M. Starr, Duncan, OK (US); Orlando De Jesus, Frisco, TX (US); Ronald L. Hinkie, Marlow, OK (US); Donald Kyle, The Colony, TX (US); Eugene Linyaev, Houston, TX (US)

Correspondence Address: KONNEKER & SMITH P. C., 660 NORTH CENTRAL EXPRESSWAY, SUITE 230, PLANO, TX, 75074, US

(21) Appl. No.: 10/913,798

(22) Filed: Aug. 6, 2004

(51) Int. Cl. H04H 9/00

(52) U.S. Cl. 367/82

(57) ABSTRACT

Acoustic telemetry installation in subterranean wells. In a described embodiment, a method of contacting an assembly with a generally tubular string in a subterranean well includes the steps of: suspending the tubular string in the well, the tubular string extending into a surface structure; and then displacing the assembly through the structure into contact with an exterior of the tubular string. The assembly can selectively contact any one of several tubular strings or other objects within a wellhead or casing. The assembly can be permanently or temporarily used on the well.

### BACKGROUND

The present invention relates generally to operations performed and equipment utilized in conjunction with a subterranean well (whether on land, underwater or offshore) and, in an embodiment described herein, more particularly provides an acoustic telemetry installation system.

It is normal practice to secure an acoustic telemetry transceiver to a tubular string at the surface by clamping the transceiver to the tubular string above a rotary table where the tubular string is suspended. This method is used, for example, in the ATS™ acoustic telemetry system marketed by Halliburton Energy Services of Houston, Tex.

Another acoustic telemetry transceiver is interconnected in the tubular string downhole. The downhole transceiver receives indications from downhole sensors and transmits these indications acoustically via the tubular string to the surface transceiver. The surface transceiver can also acoustically transmit signals (such as command and control signals) to the downhole transceiver.

Unfortunately, placement of the surface transceiver above the rotary table (where the tubular string is suspended) leads to attenuation of the acoustic signal from the downhole transceiver. In addition, surface equipment (e.g., pumps, compressors and other equipment at the surface) introduces background noise, which is difficult to filter from the attenuated acoustic signal.

In another method, an acoustic telemetry sensor (such as an accelerometer) is clamped to a tubular string prior to installing a wellhead on a well. The sensor is positioned below the wellhead when the wellhead is installed. However, this method requires the wellhead to be removed for repair or replacement of the sensor, and requires that wires or other lines for the sensor pass through the wellhead and/or seals at the time the wellhead is installed.

In yet another method, an acoustic telemetry sensor is lowered on wireline through the tubular string to a position downhole, and then anchored to the interior of the tubular string. However, this method blocks flow and access through the tubular string, requires that the wireline be present in the tubular string, and requires that access be provided at the surface for the wireline and sensor to enter the interior of the tubular string.

It will be readily appreciated that improvements are needed in the art of installing sensors and acoustic telemetry devices in wells. It is an object of the present invention to provide such improvements. Principles of the invention will also find use in other applications to achieve other objects.

### SUMMARY

In carrying out the principles of the present invention, in accordance with one of multiple embodiments described below, a method of connecting and/or contacting an acoustic telemetry device to a tubular string is provided which solves the above problems in the art.

In one aspect of the invention, a method of attenuating noise in acoustic signals communicated between surface and downhole locations of a well is provided. The method includes the steps of: attaching an acoustic telemetry device to a generally tubular string; installing the tubular string in the well so that the acoustic telemetry device is positioned at the downhole location; and then displacing another acoustic telemetry device into contact with an exterior of the tubular string.

In a further aspect of the invention, a portable installation system for use with a subterranean well includes a tubular string installed in the well and extending into a surface structure. A sensor assembly is displaced through the structure into contact with an exterior of the tubular string. The system may be used with wells currently in service, wells in production, and new wells.

In another aspect of the invention, an installation system for use with a subterranean well includes a tubular string installed either permanently or temporarily in the well and extending into a surface structure, with the tubular string being suspended from a hanger positioned above a portion of the structure. An assembly is displaced through the structure portion into contact with an exterior of the tubular string.

In yet another aspect of the invention a method of contacting an assembly with a tubular string in a subterranean well is provided. The method includes the steps of: suspending the tubular string in the well, the tubular string extending into a surface structure; and then displacing the assembly through the structure into contact with an exterior of the tubular string.

In a further aspect of the invention, an installation system for use with a subterranean well includes a tubular string installed in the well and suspended at a first location. An acoustic telemetry device is attached to the tubular string at a second location. Another acoustic telemetry device is displaced into contact with an exterior of the tubular string at a third location between the first and second locations after the tubular string is suspended at the first location.

These and other features, advantages, benefits and objects of the present invention will become apparent to one of ordinary skill in the art upon careful consideration of the detailed description below of representative embodiments of the invention and the accompanying drawings.

### BRIEF DESCRIPTION OF THE DRAWINGS

FIG. 1 is a schematic partially cross-sectional view of an acoustic telemetry installation system embodying principles of the present invention;

FIG. 2 is an enlarged scale schematic cross-sectional view through the system of FIG. 1;

FIG. 3 another enlarged scale schematic cross-sectional view through the system of FIG. 1, depicting an alternate configuration; and

FIG. 4 is another enlarged scale schematic cross-sectional view through the system of FIG. 1, depicting additional details of an embodiment of the invention.

### DETAILED DESCRIPTION

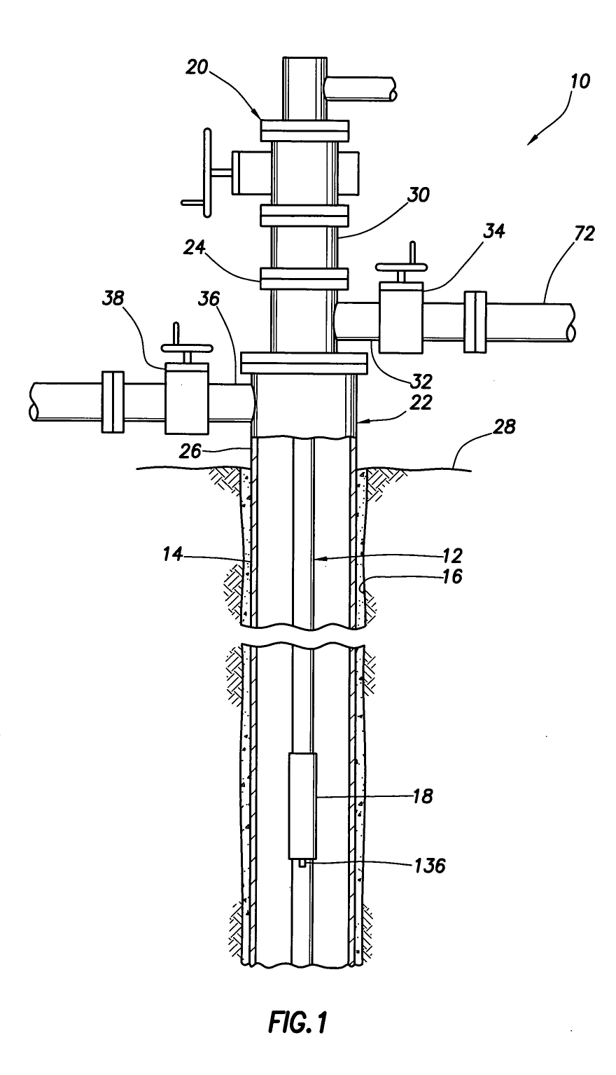

Representatively illustrated in FIG. 1 is an installation system 10 which embodies principles of the present invention. In the following description of the system 10 and other apparatus and methods described herein, directional terms, such as “above”, “below”, “upper”, “lower”, etc., are used for convenience in referring to the accompanying drawings. Additionally, it is to be understood that the various embodiments of the present invention described herein may be utilized in various orientations, such as inclined, inverted, horizontal, vertical, etc., and in various configurations, without departing from the principles of the present invention. The embodiments are described merely as examples of useful applications of the principles of the invention, which is not limited to any specific details of these embodiments.

As depicted in FIG. 1, a generally tubular string 12 (such as a production tubing string, drill string or coiled tubing string) has been installed in casing 14 lining a wellbore 16. The tubular string 12 could be of any geometric shape which encloses a gas or fluid, and may be capable of withstanding a pressure differential across the enclosure. The tubular string 12 could be any geometric shape which can support a compressive or tensile load. An exterior of the tubular string 12 can have a cylindrical or noncylindrical shape.

Interconnected in the tubular string 12 is an acoustic telemetry device 18 (such as an acoustic transceiver) which may be connected to sensors 136 downhole. For example, the device 18 could include one or more sensors 136 (e.g., annulus and/or tubing pressure, temperature, acoustic, etc. sensors), and indications from these sensors may be transmitted some distance to the surface via acoustic signals transmitted through the tubular string 12.

It is not necessary for any data or indications provided by the sensor(s) 136 in or connected to the telemetry device 18 to be transmitted immediately. Instead, the data or indications could be stored and then transmitted at a later time. One or more repeaters (not shown) may be used in the tubular string 18 to relay acoustic telemetry signals to and from the telemetry device 18.

It is not necessary in keeping with the principles of the invention for the telemetry device 18 to be interconnected as part of the tubular string 12. The telemetry device 18 could alternatively be positioned internal or external to the tubular string 12, for example, by incorporating the telemetry device in a packer or bridge plug set in the tubular string.

At the surface, the tubular string 12 is received in surface structures 20, 22. Each of the structures 20, 22 is generally tubular in shape, with the tubular string 12 extending generally coaxially therein. The structures 20, 22 are not necessarily cylindrical and can have other shapes, including but not limited to oval, elliptical, polygonal sided, etc.

The structure 20 includes a wellhead 24 with various valves, spools, flanges, pipes, etc. The wellhead 24 could instead be a BOP (blowout preventer) assembly, for example, if the tubular string 12 is coiled tubing. The structure 22 includes a portion 26 of the casing 14 which extends above a surface 28 of the earth.

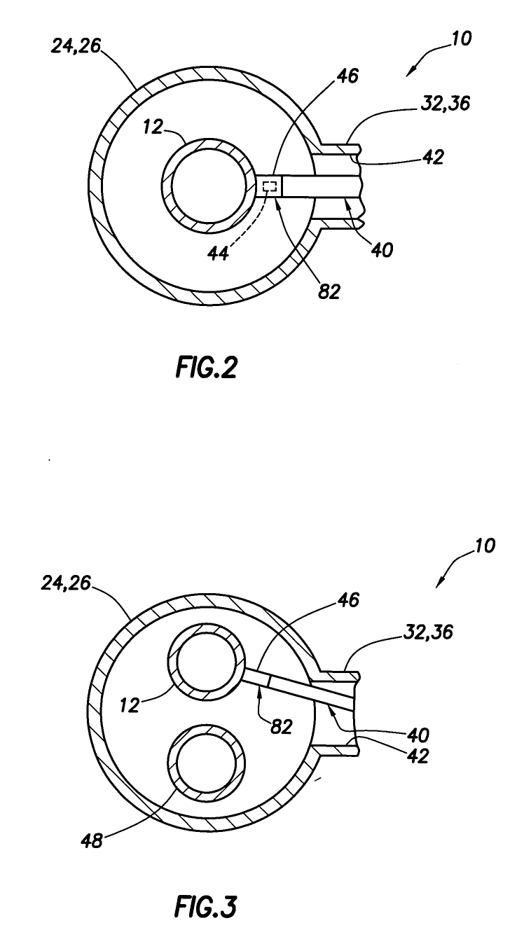

The tubular string 12 is suspended in the wellbore 16 by means of a tubing hanger 30 in the wellhead 24. In one important aspect of the system 10, an assembly 40 (such as including an acoustic telemetry device or sensor, not visible in FIG. 1, see FIGS. 2-4) is brought into contact with an exterior of the tubular string 12 below the hanger 30 through a sidewall of the wellhead 24, or through a sidewall of the casing portion 26, after the wellhead is installed.

The assembly 40 can be displaced through a sealed or unsealed sidewall of the wellhead 24 via a pipe 32 and valve 34 in communication with an interior of the wellhead. The assembly 40 can be displaced through a sealed or unsealed sidewall of the casing portion 26 via another pipe 36 and valve 38 in communication with an interior of the casing 14.

If such pipes 32, 36 and valves 34, 38 do not exist beforehand on the wellhead 24 or casing portion 26, they can be added, for example, by a process known to those skilled in the art as “line-tapping.” Thus, the system 10 can be used with existing wells that may not have been completed with provisions for displacing the assembly 40 through the sidewall of the wellhead 24 or casing portion 26.

Some benefits of this method of installation are that the assembly 40 contacts the tubular string 12 longitudinally between the hanger 30 and the telemetry device 18, any lines or wires extending to the assembly are conveniently installed after installation of the wellhead 24, and the assembly is conveniently accessible for repair, replacement or maintenance. Since the assembly 40 includes an acoustic telemetry sensor, placement of the assembly between the hanger 30 and the telemetry device 18 reduces the attenuation of the acoustic signal detected by the sensor and reduces the background noise transmitted to the sensor (e.g., from surface equipment).

At this point it should be clearly understood that the system 10 as depicted in FIG. 1 is merely a single application for the principles of the invention. For example, it is not necessary in keeping with the principles of the invention for a wellhead to be installed on a well, since the tubular string 12 could instead be suspended from a rotary table in a well testing operation, or at another suspension location. It is also not necessary for the assembly 40 to be displaced through a wellhead or a portion of casing, since the assembly could be displaced through another surface structure, such as a riser or a BOP assembly, etc.

The assembly 40 could include other types of sensors. For example, a pressure sensor could be included in the assembly 40 to monitor annulus pressure. This information would be useful in the process of installing, operating and removing the assembly 40 (e.g., for safety reasons, to aid in evaluating the received acoustic signals, etc.).

The assembly 40 could include a transmitter, a receiver or a transceiver for acoustic telemetry communication with the downhole telemetry device 18. The receiver would include the acoustic telemetry sensor, such as one or more accelerometers.

Referring now to FIG. 2, a schematic cross-sectional view of the system 10 is illustrated. The cross-section may be taken laterally through the wellhead 24 at the pipe 32 or the casing portion 26 at the pipe 36, or any other surface structure through which the assembly 40 is displaced into contact with the tubular string 12.

As depicted in FIG. 2, the assembly 40 is laterally displaced through a passage 42 in the pipe 32 or 36 into contact with an exterior of the tubular string 12. The tubular string 12 in this example is centrally located within the wellhead 24 or casing portion 26.

The assembly 40 includes a sensor 44 in a tip 46 shaped to complementarily conform to the exterior of the tubular string 12. The sensor 44 could be one or more of the sensors discussed above, such as an acoustic telemetry sensor, accelerometer or pressure sensor, etc.

If the tubular string 12 has a cylindrical exterior (e.g., as in production tubing, drill pipe, coiled tubing, etc.), then the tip 46 could have a cylindrical recess therein. If the tubular string 12 has another exterior shape (e.g., hexagonal, square, elliptical, etc.), then the tip 46 could be appropriately shaped to conform to that other shape.

The sensor 44 could be one or more accelerometers. For example, multiple accelerometers could be aligned with respective longitudinal, radial and tangential axes of the tubular string 12 to detect acoustic signals transmitted along these axes.

As discussed above, the assembly 40 could include a sensor, a receiver, a transmitter, any combination of these, etc. Thus, the assembly 40 can include any type of acoustic telemetry device 82.

Referring additionally to FIG. 3, the system 10 is depicted in an alternate configuration in which the tubular string 12 is not centrally or coaxially positioned within the wellhead 24 or casing portion 26. Instead, the tubular string 12 is off-center in the wellhead 24 or casing portion 26.

This may be the situation, for example, in a dual or multiple string completion where at least one other tubular string 48 shares the space within the wellhead 24 or casing portion 26. In this case, the assembly 40 may be directed at an angle through the passage 42 toward the tubular string 12 (or the tubular string 48, if desired).

As with the tubular string 12, the tubular string 48 is not necessarily cylindrical in shape, but can have any geometric shape. It is also not necessary for any particular structure to be present in the wellhead 24 or casing 26 along with the tubular string 12 in order for the assembly 40 to be directed at an angle through the passage 42.

Multiple ones of the assembly 40 may be used at the same time to contact the multiple tubular strings 12, 48. Each of the assemblies 40 would contact a respective one of the tubular strings 12, 48. In this manner, one of the assemblies 40 can be used to communicate with a downhole telemetry device via one of the tubular strings 12, 48 while another of the assemblies can be used to communicate with another downhole telemetry device via the other tubular string.

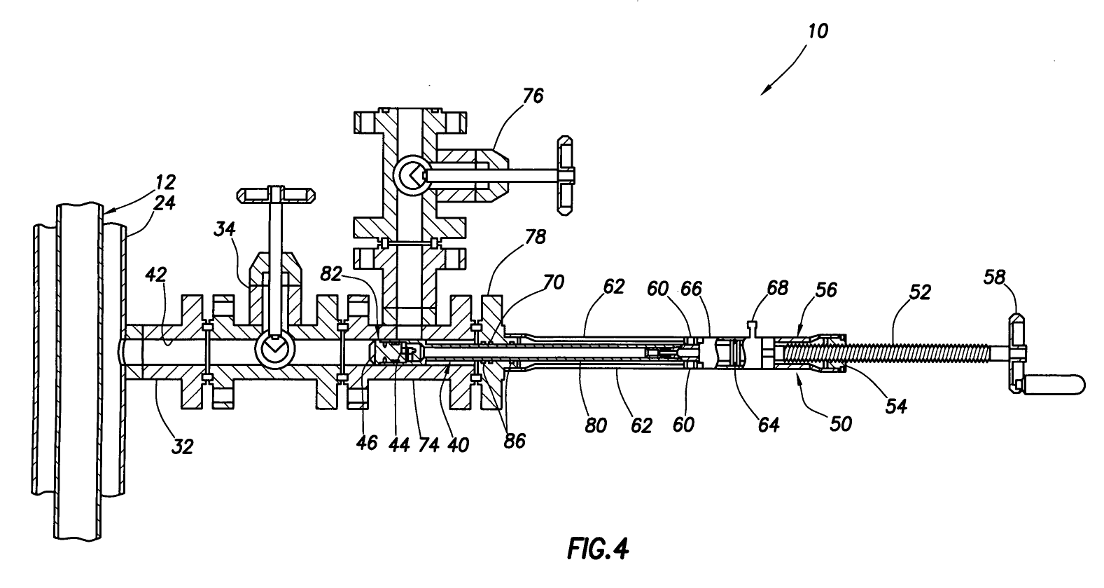

Referring additionally now to FIG. 4, a more detailed cross-sectional view of the system 10 is illustrated. For clarity of description, the casing portion 26 is not illustrated in FIG. 4, the assembly 40 being displaced instead through the wellhead 24, but it should be understood that the assembly 40 can be displaced through a sidewall of the casing portion if desired.

In this view it may be seen that a biasing device 50 is used to displace the assembly 40 through the passage 42 into contact with the tubular string 12 within the wellhead 24. The biasing device 50 includes an externally threaded shaft 52 received in an internally threaded and sealed collar 54 attached to a housing assembly 56.

By rotating a handwheel 58 on the shaft 52, the assembly 40 may be gradually displaced under pressure through the passage 42 into contact with the tubular string 12. In addition, a sufficient biasing force may be applied using the handwheel 58 to maintain the tip 46 of the assembly 40 in contact with the tubular string 12, even though the tubular string may displace somewhat within the wellhead 24.

Lugs 60 engage slots 62 in the housing assembly 56 to prevent the assembly 40 from rotating when the shaft 52 is rotated using the handwheel 58. Of course, other means of displacing the assembly 40 could be used (such as motors, hydraulic or pneumatic actuators, etc.) in place of, or in addition to, the threaded shaft 52 and collar 54.

To provide a more resilient or consistent application of the biasing force to the assembly 40, the biasing device 50 includes a hydraulic or pneumatic actuator 66. Pressure is applied via a port 68 to one side of a piston 64 to bias the assembly 40 toward the tubular string 12.

By maintaining a consistent pressure on the piston 64, a consistent biasing force may be maintained against the exterior of the tubular string 12, whether or not the tubular string displaces somewhat in the wellhead 24. Thus, the threaded shaft 52 and collar 54 may be used for a “coarse” displacement of the assembly 40, while the actuator 66 may be used for a final “fine” displacement of the assembly into contact with the tubular string 12 and application of the biasing force.

If pressure exists in the wellhead 24 (for example, as would be the case at times in fracturing, gravel packing, testing, etc. operations), then this pressure will be applied via the passage 42 to the assembly 40 when the valve 34 is opened to permit the assembly to be displaced therethrough. Alternatively, or in addition, another pressure source (such as a pump truck) could supply backside pressure via valve 76, e.g., to balance an overpressured tubing during a job.

The assembly 40 is sealed (for example, by seal 70) to prevent this pressure from escaping. Rod wipers 86 are provided to either side of the seal 70.

However, this pressure will also bias the assembly 40 to displace away from the tubular string 12 (for example, by applying a biasing force to the assembly, piston 64, etc.), so that pressure applied to the port 68 of the actuator 66 will need to be increased to counteract this biasing force. In order to reduce or eliminate the increased pressure applied to the actuator 66 to counteract the pressure in the wellhead 24, the assembly 40 may be partially or completely pressure balanced with respect to pressure in the wellhead. For example, a line (not shown), such as a flexible hose, may be used to transmit pressure from the interior of the wellhead 24 to the interior of the housing assembly 56.

Note that other types of biasing means may be used in the biasing device 50 to apply the biasing force to the assembly 40. For example, compression springs, extension springs, pressurized chambers, etc. could be used in place of, or in addition to, the shaft 52, collar 54 and actuator 66.

In practice, the system 10 would be installed as follows:

1. The valve 34 would be closed.

2. Any pipe or other equipment 72 (see FIG. 1) connected to the valve 34 would be depressurized, drained and disconnected.

3. A tee 74 and valve 76 would be attached to the valve 34. The pipe or other equipment 72 disconnected from the valve 34 in step 2 would now be connected to the valve 76. In this manner, the system 10 permits continuation of any previous operations, such as application of pressure or circulation of fluids in the casing 14 via the passage 42. If no pipe or other equipment 72 needs to be used, then the tee 74 and valve 76 may not be used in the system 10.

4. The assembly 40 and biasing device 50 would then be connected via a flange 78 on the housing assembly 56 to the tee 74. If the tee 74 and valve 76 are not used, then the flange 78 may be connected directly to the valve 34.

5. If desired, a pressure balance line would then be connected to apply pressure from the interior of the wellhead 24 to the interior of the housing assembly 56, as described above.

6. The valve 34 would then be opened. The valve 76 may also be opened, either before or after the valve 34 is opened, if desired to provide communication with the pipe or other equipment 72.

7. The biasing device 50 would then be used to displace the assembly 40 through the valve 34 and passage 42, until the tip 46 makes contact with the exterior of the tubular string 12. The handwheel 58 could be used to displace the tip 46 into close proximity to the tubular string 12, and then the actuator 66 could be used to displace the tip into actual contact with the tubular string and apply the biasing force to maintain such contact.

The sensor 44 may communicate with surface equipment (such as a control module, recording station, etc.) via wireless telemetry. As an alternative, wires or other lines may extend between the sensor 44 and the surface equipment, in which case the wires or lines may extend through the assembly 40 and exit via the slots 62 in the housing assembly 56 (e.g., through the lugs 60).

Instead of the straight passage 42 depicted in FIG. 4, in some cases the passage could be curved, such as when an elbow (e.g., a 45 or 90 degree curve) is used on the wellhead 24 to provide communication with its interior. In those cases, the assembly 40 could include an elongated flexible portion 80, which would allow the assembly to pass through a curvature in the passage 42.

Where the tubular string 12 is not centrally located in the wellhead 24 (e.g., as depicted in FIG. 3), the assembly 40 or its housing assembly 56 may be configured so that the assembly is displaced at an angle, or otherwise off-center. For example, the flange 78 could be angled with respect to the remainder of the housing assembly 56 so that, depending upon how the flange 78 is connected to the tee 74 or valve 34, the assembly 40 may be directed to the left or to the right as it displaces through the passage 42.

Of course, a person skilled in the art would, upon a careful consideration of the above description of representative embodiments of the invention, readily appreciate that many modifications, additions, substitutions, deletions, and other changes may be made to these specific embodiments, and such changes are within the scope of the principles of the present invention. Accordingly, the foregoing detailed description is to be clearly understood as being given by way of illustration and example only, the spirit and scope of the present invention being limited solely by the appended claims and their equivalents.

What is claimed is:

1. A method of attenuating noise in acoustic signals communicated between surface and downhole locations of a well, the method comprising the steps of:
attaching a first acoustic telemetry device to a generally tubular string;
installing the tubular string in the well so that the first acoustic telemetry device is positioned at the downhole location; and
displacing a second acoustic telemetry device into contact with an exterior of the tubular string.

2. The method of claim 1, further comprising the step of transmitting acoustic signals between the first and second acoustic telemetry devices via the tubular string.

3. The method of claim 1, further comprising the step of the second acoustic telemetry device sensing the acoustic signals transmitted via the tubular string, the signals indicating at least one parameter sensed by at least one downhole sensor in the well.

4. The method of claim 3, further comprising the step of connecting the downhole sensor to the first acoustic telemetry device.

5. The method of claim 1, wherein the displacing step is performed without clamping the second acoustic telemetry device to the tubular string.

6. The method of claim 1, wherein the displacing step is performed without permanently securing the second acoustic telemetry device to the tubular string.

7. The method of claim 1, wherein the displacing step is performed without obstructing an interior of the tubular string.

8. The method of claim 1, wherein the displacing step is performed without impeding flow and access through the tubular string.

9. The method of claim 1, wherein the installing step further comprises suspending the tubular string at a suspension location, and wherein the displacing step further comprises the second acoustic telemetry device contacting the exterior of the tubular string between the downhole location and the suspension location.

10. The method of claim 9, wherein the suspension location is at the surface location.

11. The method of claim 9, wherein the suspension location is at a wellhead.

12. The method of claim 9, wherein the suspension location is at a rotary table.

13. The method of claim 9, wherein the suspension location is at a hanger.

14. The method of claim 1, wherein the displacing step further comprises displacing the second acoustic telemetry device generally laterally through a sidewall of a generally tubular surface structure.

15. The method of claim 14, wherein the structure is a wellhead.

16. The method of claim 14, wherein the structure is a casing.

17. The method of claim 1, further comprising the step of using a biasing device to maintain contact between the second acoustic telemetry device and the tubular string while the tubular string displaces.

18. The method of claim 1, wherein the installing step further comprises suspending the tubular string by a hanger, and wherein the displacing step further comprises the second acoustic telemetry device contacting the tubular string below the hanger.

19. The method of claim 1, wherein the displacing step further comprises the second acoustic telemetry device contacting the tubular string below a wellhead.

20. The method of claim 1, wherein the displacing step is performed after a wellhead is installed on the well.

21. The method of claim 1, wherein the second acoustic telemetry device includes an acoustic telemetry receiver.

22. The method of claim 1, wherein the second acoustic telemetry device includes an acoustic telemetry transmitter.

23. The method of claim 1, wherein the second acoustic telemetry device includes at least one sensor.

24. The method of claim 1, wherein there is a plurality of the tubular strings, a plurality of the first acoustic telemetry devices and a plurality of the second acoustic telemetry devices, and wherein the displacing step further comprises contacting each of the second acoustic telemetry devices with a respective one of the tubular strings and communicating with a respective one of the first acoustic telemetry devices.

25. The method of claim 1, wherein the displacing step is performed after the installing step.

26. An installation system for use with a subterranean well, the system comprising:
a generally tubular string installed in the well and extending into a surface structure; and
a sensor assembly displaced through the structure into contact with an exterior of the tubular string.

27. The system of claim 26, wherein the structure is generally tubular, and wherein the sensor assembly is displaced generally laterally through a sidewall of the structure.

28. The system of claim 26, wherein the structure is a wellhead.

29. The system of claim 26, wherein the structure is a casing.

30. The system of claim 26, wherein a biasing device maintains contact between the sensor assembly and the tubular string while the tubular string displaces within the structure.

31. The system of claim 26, wherein the sensor assembly contacts the tubular string below a hanger.

32. The system of claim 26, wherein the sensor assembly contacts the tubular string below a wellhead.

33. The system of claim 26, wherein the sensor assembly contacts the tubular string after a wellhead is installed on the well.

34. The system of claim 26, wherein the sensor assembly includes an acoustic telemetry receiver.

35. The system of claim 26, wherein the sensor assembly includes an acoustic telemetry transmitter.

36. The system of claim 26, wherein there is a plurality of the tubular strings and a plurality of the sensor assemblies, each of the sensor assemblies being in contact with, and receiving acoustic signals from, a respective one of the tubular strings.

37. The system of claim 26, wherein the sensor assembly senses acoustic signals transmitted via the tubular string, the signals indicating at least one parameter sensed by at least one downhole sensor in the well.

38. The system of claim 37, wherein the downhole sensor is connected to a telemetry device interconnected in the tubular string downhole.

39. An installation system for use with a subterranean well, the system comprising:
a generally tubular string installed in the well and extending into a surface structure, the tubular string being suspended from a hanger positioned above a portion of the structure; and
an assembly displaced through the structure portion into contact with an exterior of the tubular string.

40. The system of claim 39, wherein the assembly includes at least one sensor.

41. The system of claim 40, wherein the sensor is an accelerometer.

42. The system of claim 40, wherein the sensor is a pressure sensor.

43. The system of claim 40, wherein the sensor is an acoustic telemetry sensor.

44. The system of claim 39, wherein the structure is generally tubular, and wherein the assembly is displaced generally laterally through a sidewall of the structure.

45. The system of claim 39, wherein the structure is a wellhead.

46. The system of claim 39, wherein the structure is a casing.

47. The system of claim 39, wherein a biasing device maintains contact between the assembly and the tubular string while the tubular string displaces within the structure.

48. The system of claim 47, wherein the biasing device includes a first pressure applied to a piston to bias the piston toward the tubular string.

49. The system of claim 48, wherein a second pressure within the structure biases the piston away from the tubular string.

50. The system of claim 47, wherein the biasing device includes a spring.

51. The system of claim 47, wherein the biasing device includes a pressurized chamber.

52. The system of claim 47, wherein the biasing device includes threads.

53. The system of claim 39, wherein the assembly contacts the tubular string below a wellhead.

54. The system of claim 53, wherein the assembly contacts the tubular string below the wellhead after the wellhead is installed on the well.

55. The system of claim 53, wherein the assembly is displaced through a valve positioned below the wellhead.

56. The system of claim 55, wherein the valve is attached to casing below the wellhead.

57. The system of claim 39, wherein the assembly contacts the tubular string after a wellhead is installed on the well.

58. The system of claim 57, wherein the assembly contacts the tubular string through the wellhead.

59. The system of claim 57, wherein the assembly contacts the tubular string through casing below the wellhead.

60. The system of claim 57, wherein the assembly contacts the tubular string through a valve attached to the wellhead.

61. The system of claim 39, wherein the assembly includes an acoustic telemetry receiver.

62. The system of claim 61, wherein the receiver includes at least one accelerometer.

63. The system of claim 61, wherein the receiver includes multiple accelerometers aligned with multiple respective axes relative to the tubular string.

64. The system of claim 39, wherein the assembly includes an acoustic telemetry transmitter.

65. The system of claim 39, wherein the assembly includes a flexible portion.

66. The system of claim 65, wherein the flexible portion is displaced at least partially through a curvature in a passage extending into the structure.

67. The system of claim 39, wherein the assembly contacts the tubular string at a position between the hanger and an acoustic telemetry receiver attached to the tubular string.

68. The system of claim 39, wherein the assembly contacts the tubular string at a position between the hanger and an acoustic telemetry transmitter attached to the tubular string.

69. The system of claim 39, wherein there is a plurality of the tubular strings and a plurality of the assemblies, each of the assemblies being in contact with, and communicating acoustic signals with, a respective one of the tubular strings.

70. The system of claim 39, wherein the assembly senses acoustic signals transmitted via the tubular string, the signals indicating at least one parameter sensed by at least one downhole sensor in the well.

71. The system of claim 70, wherein the downhole sensor is connected to a telemetry device interconnected in the tubular string downhole.

72. A method of contacting an assembly with a generally tubular string in a subterranean well, the method comprising the steps of:
suspending the tubular string in the well, the tubular string extending into a surface structure; and
then displacing the assembly through the structure into contact with an exterior of the tubular string.

73. The method of claim 72, wherein the suspending step further comprises suspending the tubular string from a hanger.

74. The method of claim 73, wherein the displacing step further comprises displacing the assembly through a portion of the structure positioned below the hanger.

75. The method of claim 73, wherein the displacing step further comprises contacting the assembly with the tubular string at a position between the hanger and an acoustic telemetry receiver attached to the tubular string.

76. The method of claim 73, wherein the displacing step further comprises contacting the assembly with the tubular string at a position between the hanger and an acoustic telemetry transmitter attached to the tubular string.

77. The method of claim 72, further comprising the step of providing the assembly including at least one sensor.

78. The method of claim 77, wherein in the providing step the sensor is an accelerometer.

79. The method of claim 77, wherein in the providing step the sensor is a pressure sensor.

80. The method of claim 77, wherein in the providing step the sensor is an acoustic telemetry sensor.

81. The method of claim 72, wherein the structure is generally tubular, and wherein the displacing step further comprises displacing the assembly generally laterally through a sidewall of the structure.

82. The method of claim 72, wherein in the suspending step the structure is a wellhead.

83. The method of claim 72, wherein in the suspending step the structure is a casing.

84. The method of claim 72, wherein the displacing step further comprises biasing the assembly to maintain contact with the tubular string while the tubular string displaces within the structure.

85. The method of claim 84, wherein the biasing step further comprises applying a first pressure to a piston to bias the piston toward the tubular string.

86. The method of claim 85, wherein in the biasing step a second pressure within the structure biases the piston away from the tubular string.

87. The method of claim 84, wherein in the biasing step a spring biases the assembly into contact with the tubular string.

88. The method of claim 84, wherein in the biasing step a pressurized chamber biases the assembly into contact with the tubular string.

89. The method of claim 84, wherein in the biasing step threads bias the assembly into contact with the tubular string.

90. The method of claim 72, wherein the displacing step further comprises contacting the assembly with the tubular string below a wellhead.

91. The method of claim 90, wherein the contacting step is performed after the wellhead is installed on the well.

92. The method of claim 90, wherein the displacing step further comprises displacing assembly through a valve positioned below the wellhead.

93. The method of claim 92, further comprising the step of attaching the valve to casing below the wellhead.

94. The method of claim 72, further comprising the step of installing a wellhead on the well, and wherein the displacing step is performed after the installing step.

95. The method of claim 94, wherein the displacing step further comprises contacting the assembly with the tubular string through the wellhead.

96. The method of claim 94, wherein the displacing step further comprises contacting the assembly with the tubular string through casing below the wellhead.

97. The method of claim 94, wherein the displacing step further comprises contacting the assembly with the tubular string through a valve attached to the wellhead.

98. The method of claim 72, wherein in the displacing step the assembly includes an acoustic telemetry receiver.

99. The method of claim 98, wherein in the displacing step the receiver includes at least one accelerometer.

100. The method of claim 98, wherein in the displacing step the receiver includes multiple accelerometers aligned with multiple respective axes relative to the tubular string.

101. The method of claim 72, wherein in the displacing step the assembly includes an acoustic telemetry transmitter.

102. The method of claim 72, wherein in the displacing step the assembly includes a flexible portion.

103. The method of claim 102, wherein the displacing step further comprises displacing the flexible portion at least partially through a curvature in a passage extending into the structure.

104. The method of claim 72, wherein there is a plurality of the tubular strings and a plurality of the assemblies, and wherein the displacing step further comprises displacing each of the assemblies into contact with a respective one of the tubular strings.

105. The method of claim 104, further comprising the step of communicating acoustic signals between each of the assemblies and the respective one of the tubular strings.

106. The method of claim 72, further comprising the step of the assembly sensing acoustic signals transmitted via the tubular string, the signals indicating at least one parameter sensed by at least one downhole sensor in the well.

107. The method of claim 106, further comprising the steps of connecting the downhole sensor to a telemetry device, and interconnecting the telemetry device in the tubular string.

108. An installation system for use with a subterranean well, the system comprising:
a generally tubular string installed in the well and suspended at a first location;
a first acoustic telemetry device attached to the tubular string at a second location; and
a second acoustic telemetry device displaced into contact with an exterior of the tubular string at a third location between the first and second locations after the tubular string is suspended at the first location.

109. The system of claim 108, wherein second acoustic telemetry device is displaced generally laterally through a sidewall of a generally tubular surface structure.

110. The system of claim 109, wherein the structure is a wellhead.

111. The system of claim 109, wherein the structure is a casing.

112. The system of claim 108, wherein a biasing device maintains contact between the second acoustic telemetry device and the tubular string while the tubular string displaces.

113. The system of claim 108, wherein the tubular string is suspended at the first location by a hanger, the second acoustic telemetry device being positioned below the hanger.

114. The system of claim 108, wherein the third location is positioned below a wellhead.

115. The system of claim 108, wherein the second acoustic telemetry device contacts the tubular string only after a wellhead is installed on the well.

116. The system of claim 108, wherein the second acoustic telemetry device includes an acoustic telemetry receiver.

117. The system of claim 108, wherein the second acoustic telemetry device includes an acoustic telemetry transmitter.

118. The system of claim 108, wherein the second acoustic telemetry device includes at least one sensor.

119. The system of claim 108, wherein there is a plurality of the tubular strings, a plurality of the first acoustic telemetry devices and a plurality of the second acoustic telemetry devices, each of the second acoustic telemetry devices being in contact with a respective one of the tubular strings and communicating with a respective one of the first acoustic telemetry devices.

120. The system of claim 108, wherein the second acoustic telemetry device senses acoustic signals transmitted via the tubular string, the signals indicating at least one parameter sensed by at least one downhole sensor in the well.

121. The system of claim 120, wherein the downhole sensor is connected to the first acoustic telemetry device interconnected in the tubular string downhole.
